(19) United States
(12) Patent Application Publication
(10) Pub. No.: US 2014/0373807 A1
(43) Pub. Date: Dec. 25, 2014

(54) METHOD AND APPARATUS FOR CONVERTING A DIESEL ENGINE TO BE POWERED BY NATURAL GAS

(71) Applicant: Georgetown Rail Equipment Company, Georgetown, TX (US)

(72) Inventors: Carlos Alberto Repelli, Georgetown, TX (US); Edwin DeSteiguer Snead, Georgetown, TX (US); Thomas Schwertner, Jarrell, TX (US)

(21) Appl. No.: 14/308,297

(22) Filed: Jun. 18, 2014

Related U.S. Application Data
(60) Provisional application No. 61/837,048, filed on Jun. 19, 2013.

(51) Int. Cl. F02M 21/02; F02P 13/00

(52) U.S. Cl. CPC F02M 21/029; F02M 21/0248; F02P 13/00
USPC 123/297; 29/888.011

(57) ABSTRACT

A method for converting a fuel-injected diesel engine to be powered by natural gas includes removing a fuel injector from a cylinder of the engine, replacing the removed fuel injector with a combined fuel injection and ignition unit having a natural gas flow path and an ignition device, coupling the natural gas flow path to a pressurized natural gas fuel supply, and connecting the ignition device to an ignition control system. The combined fuel injection and ignition unit is configured to inject the natural gas into the cylinder, and the ignition device is configured to ignite the natural gas in the cylinder, under control and coordination of the ignition control system for operation of the engine.

### PRIORITY CLAIM

This application claims priority under 35 USC §119 to U.S. Provisional Patent Application Ser. No. 61/837,048 filed on Jun. 19, 2013, and titled “Method and Apparatus for Converting 645E Blower Type Locomotive Diesel Engines to be Powered by Natural Gas,” the entire contents of which are hereby incorporated by reference.

### BACKGROUND

1. Field of the Invention

The present application relates to the conversion of compression engines to run on natural gas. More specifically, the present application presents a method and apparatus for converting a 645E blower-type diesel engine to run on natural gas.

2. Related Art

There are a variety of types of compression engines that are used for marine engines, railroad locomotives and the like. The blower-type 645E engine is a type of large compression or diesel piston engine that is widely used in railroad locomotives and in other applications in North America and around the world. This particular engine entered production in the mid 1960's, and can be found in 8, 12 and 16-cylinder models. A turbocharged version of this engine is also available in a 20-cylinder model, which is designated as Model 645E3. By virtue of its design, the 645E provides high horsepower per unit weight and a high compression ratio (e.g. 16:1).

All 645E engines are two-stroke 45-degree V-engines that run on diesel fuel. The engine is a uniflow design with four poppet-type exhaust valves in the cylinder head for each cylinder, and charge air scavenging ports within the sides of the cylinders for combustion air intake. The engine uses a single overhead camshaft per bank of cylinders, with exhaust valves operated by two cam lobes (each of which operates two exhaust valves through a “bridge”) and one cam lobe to operate the unit injector (fuel injector) which is in the center of the four exhaust valves in each cylinder. In a two-cycle engine, each cylinder completes a power cycle with each revolution of the crankshaft. A blower is provided in the 645E engine to supply the needed combustion air (which enters the cylinders through the charge air scavenging ports) and to purge the combustion gases from the cylinder.

The 645E engine was designed to run on diesel fuel. However, in recent years natural gas has become more popular as an economical and clean fuel for many applications, including motor vehicles. Moreover, recent increases in the quantity of natural gas being extracted within the United States and elsewhere have pushed natural gas prices to near historic lows. At the present time, it is estimated that the equivalent cost per BTU for natural gas is around 15% that of diesel fuel. It is believed that replacing diesel engines with natural gas engines could result in dramatic efficiency improvements in terms of cost of operation and environmental impact. Replacing entire engines, however, along with fuel storage and delivery systems and other components of a vehicle that are required for using natural gas as a motor fuel, can be very expensive.

The present disclosure is directed toward one or more of the above-noted issues.

### SUMMARY

It has been recognized that it would be desirable to retrofit existing diesel engines, such as the 645E blower-type engine, to run on natural gas.

It has also been recognized that it would be desirable to retrofit existing diesel engines to run on natural gas with minimal modifications.

In accordance with one aspect thereof, the present disclosure is directed to a method for converting a fuel-injected diesel engine to be powered by natural gas. The method includes removing a fuel injector from a cylinder of the engine, replacing the removed fuel injector with a combined fuel injection and ignition unit having a natural gas flow path and an ignition device, coupling the natural gas flow path to a pressurized natural gas fuel supply, and connecting the ignition device to an ignition control system. The combined fuel injection and ignition unit is configured to inject the natural gas into the cylinder, and the ignition device is configured to ignite the natural gas in the cylinder, under control and coordination of the ignition control system for operation of the engine.

In accordance with another aspect thereof, the present disclosure provides a natural gas engine system, including a piston engine, having multiple cylinders, originally adapted to burn diesel fuel introduced into each cylinder via a fuel injector, a natural gas fuel supply, a fuel injection and ignition unit, associated with each cylinder in place of the fuel injectors, and an ignition control system. The fuel injection and ignition unit is connected to the natural gas fuel supply, and has a fuel flow path and an ignition device. The fuel injection and ignition unit is configured to introduce fuel into the respective cylinder and to ignite the fuel therein. The ignition control system is coupled to the natural gas fuel supply and the fuel injection and ignition unit, and is configured to control the introduction of the natural gas fuel into the respective cylinder and to ignite the fuel via the fuel injection and ignition unit.

In accordance with yet another aspect thereof, the disclosure provides a fuel injection and ignition unit for converting a diesel piston engine having multiple cylinders to burn natural gas. The fuel injection and ignition unit includes a body, configured to replace a diesel fuel injector associated with a cylinder of the piston engine, the body having a proximal end, configured to receive natural gas fuel at an elevated pressure, and a distal end that is positionable at a combustion chamber of the cylinder. The unit also includes a fuel flow channel, extending from the proximal end to the distal end, a discharge port at the distal end, in communication with the fuel flow channel, configured to introduce fuel into the combustion chamber, and an ignition device, disposed at the distal end, configured to ignite the fuel in the combustion chamber.

### BRIEF DESCRIPTION OF THE DRAWINGS

FIG. 1A is a cross-sectional view of a typical 645E blower-type diesel engine having standard fuel injectors.

FIG. 1B is a close-up cross-sectional view of the upper portion a single cylinder of the engine of FIG. 1A, showing the relationship of the fuel injector to other components.

FIG. 2 is a standard timing diagram for one cylinder of a 645E blower-type diesel engine.

FIG. 3 is a schematic diagram of a 645E blower-type diesel engine and its fuel supply and ignition system that has been modified to run on natural gas in accordance with the present disclosure, showing the ignition control module and related components.

FIG. 4 is a close-up cross-sectional view of the upper portion a single cylinder of a 645E blower-type diesel engine that has been retrofitted with a fuel injection and ignition unit in accordance with the present disclosure.

FIG. 5 is a timing diagram for one cylinder of a 645E blower-type diesel engine that has been retrofitted to run on natural gas using a fuel injection and ignition unit in accordance with the present disclosure.

FIGS. 6A and 6B are longitudinal cross-sectional views of an embodiment of a fuel injection and ignition unit that can take the place of a standard fuel injector of a 645E blower-type diesel engine, in accordance with the present disclosure.

FIG. 7 is a transverse cross-sectional view of the fuel injection and ignition unit of FIGS. 6A and 6B.

FIGS. 8A and 8B are longitudinal cross-sectional views of another embodiment of a fuel injection and ignition unit in accordance with the present disclosure.

FIGS. 9A and 9B are transverse cross-sectional views of the fuel injection and ignition unit of FIGS. 7A and 7B.

FIG. 10 is an exemplary engine performance curve, indicating the degree of advance of the spark for different engine operating speeds for a 645E blower-type diesel engine that has been retrofitted to run on natural gas in accordance with the present disclosure.

While the disclosure is susceptible to various modifications and alternative forms, specific embodiments have been shown by way of example in the drawings and will be described in detail herein. However, it should be understood that the disclosure is not intended to be limited to the particular forms disclosed. Rather, the intention is to cover all modifications, equivalents and alternatives falling within the spirit and scope of the invention as defined by the appended claims.

### DETAILED DESCRIPTION

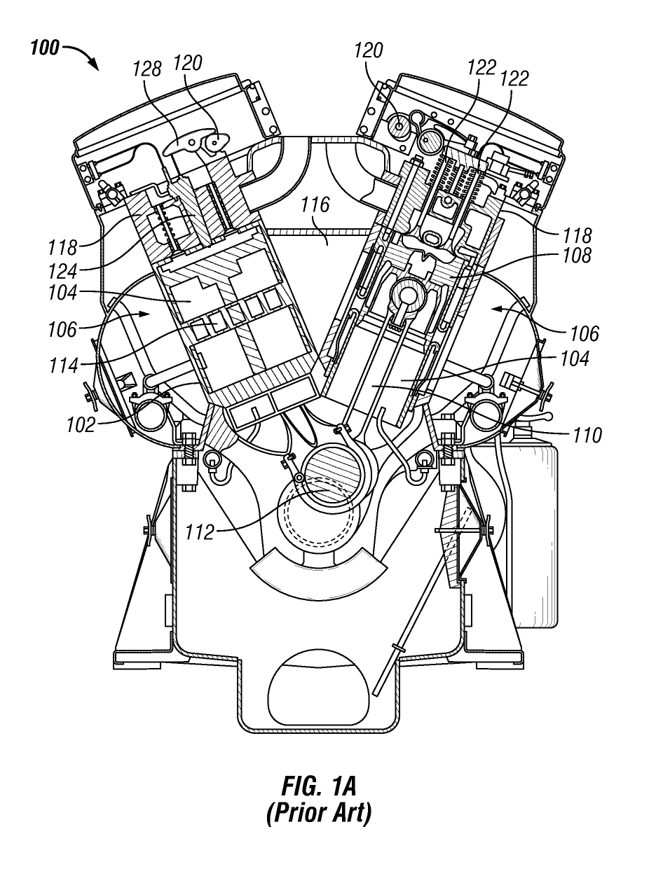

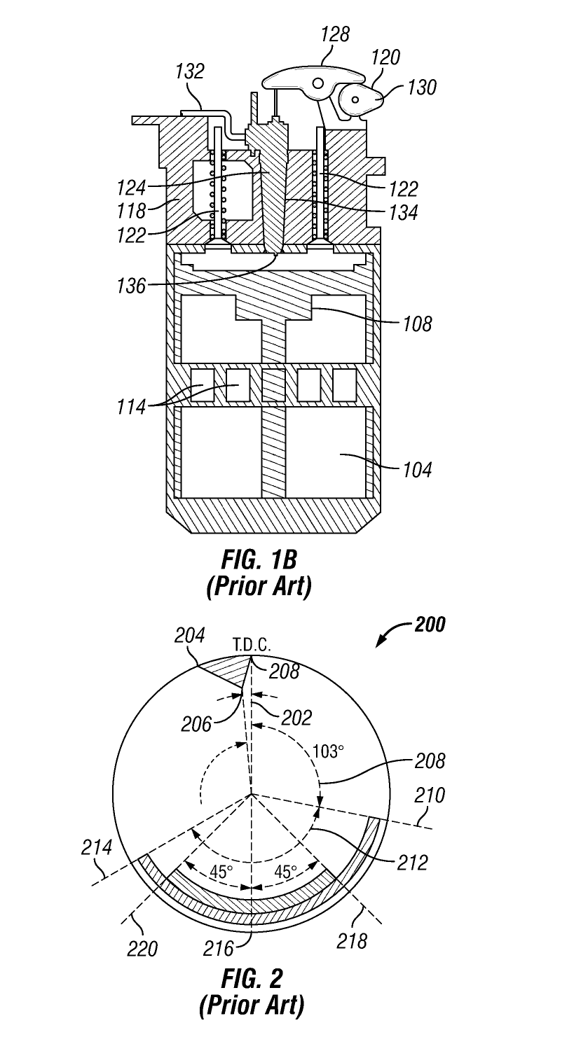

A cross-sectional view of a standard 645E engine 100 is shown in FIG. 1A. The engine 100 generally includes an engine block 102, which includes multiple cylinders 104 in two side-by-side cylinder banks 106 oriented at a 450 angle to each other. Within each cylinder 104 is a reciprocating piston 108 (shown on the right in FIG. 1), each of the pistons 108 having a piston rod 110 that connects to a common crankshaft 112 located below all of the cylinders 104. In the sides of the cylinders 104 are intake ports 114, through which intake air for combustion enters the cylinder 104 from an intake manifold 116 as the respective piston moves downward and uncovers the intake ports 114 (shown on the left in FIG. 1) with each reciprocation of the piston 108. Atop each bank 106 of cylinders 104 is a cylinder head 118, which includes a camshaft 120 that operates a group of exhaust valves 122 and a fuel injector 124. Each cylinder 104 is fired in a pre-determined sequence, and the associated piston 108 transfers its power through the piston rod 110 to the crankshaft 112. In a railroad locomotive embodiment of the 645E engine, the rotation of the crankshaft 112 is transferred to a flywheel (not shown in FIG. 1), which is located at the coupling end of the rear of the locomotive, and also to a generator (not shown), which generates electrical power for the DC traction motors (not shown), as understood by those of skill in the art.

The actuation of each cylinder 104 and the movement of its associated valves 122 and injectors 124 is controlled and synchronized by the camshaft 120. Shown in FIG. 1B is a close-up cross-sectional view of the upper portion a single cylinder 104 of the engine 100 of FIG. 1A, showing the relationship of the fuel injector 124 to other components. The head 126 of the fuel injector 124 is actuated by a rocker arm 128, which contacts one lobe 130 of the camshaft 120 and is thus caused to inject fuel into the cylinder 104 at a specific time with each rotation of the camshaft 120. The injector 124 and its mechanism are responsible to inject the right amount of fuel at the precise time. The injectors 124 are connected to each other by a fuel line/fuel rail and fuel manifold (not shown), to which each injector 124 is connected. Each fuel injector 124 includes a shaft which contacts a rocker arm, which actuates the injector to control injection of the fuel. Each injector 124 thus causes injection of fuel into the cylinder 104 with each actuation, the quantity of fuel injected being determined by a governor (not shown). Each fuel injector 124 is located and seated in a tapered hole 134 in the center of each cylinder head 118, with the spray tip 136 of the injector 124 protruding slightly below the bottom of the head 118.

The operation of each cylinder 104 of a standard 645E diesel engine 100 follows the general timing diagram 200 shown in FIG. 2. This diagram represents the relative angular positions of the crankshaft (112 in FIG. 1A) at which various mechanically coupled actions occur with each rotation of the crank in a standard 645E engine. As will be appreciated by those of skill in the art, “TDC” stands for Top Dead Center, which represents the extreme upper position of the piston (108 in FIG. 1A) inside the cylinder (104 in FIG. 1A), and is represented by a “12 o'clock” position 202 on the timing diagram 200. As the piston approaches the TDC position 202, all valves are closed and the fuel-air mixture inside the cylinder is compressed by the piston into a small volume (at e.g. a 16:1 compression ratio) within the upper portion of the cylinder, and naturally heats up due to this compression. At a fuel injection point 204 before the piston reaches TDC 202 (e.g. 6° before TDC 202), a fuel injector begins to spray fuel into the cylinder. Upon injection of the fuel, ignition follows very rapidly at a combustion point 206 (e.g. 4° before TDC), due to the temperature and pressure of the compressed fuel-air mixture. The fuel burns rapidly and forces the piston down in what is called the power stroke of the piston, indicated at 208.

Once the piston rotates the crank a given angular amount during the power stroke 208, the intake and exhaust valves open and close at respective points, according to the cycle shown in FIG. 2. For example, when the crank has rotated 103^{°}, the exhaust valves open, as indicated at 210, allowing hot combustion gasses to escape from the cylinder. The exhaust valves can remain open for the following 138° of rotation of the crank, indicated by arrow 212, until reaching a closure point indicated at 214, which includes passage of the piston below the bottom dead center point 216 of its motion (exactly 180° opposite TDC 202).

As those of skill in the art will appreciate, a two stroke engine can employ intake ports, rather than intake valves, as shown and described in connection with FIG. 1A above. In the 645E engine, as shown in FIG. 2, the intake ports are positioned to be open within 45° of the bottom dead center position 216. Thus, as the crank rotates past point 218 at a crank angle of 135^{°}, the piston uncovers these ports in its downward motion, and the air intake ports open and remain open until the piston rises to block them again at the 225^{°} position 220. It will be apparent from the diagram of FIG. 2 that the exhaust valves open (at point 210) prior to opening of the intake ports (at point 218), and remain open after closing of the intake ports (at point 220). This allows hot, high pressure combustion gasses to begin to exit the cylinder before intake air enters, and also allows incoming intake air and the upward motion of the piston, after passing the bottom dead center position 216, to help push the remaining exhaust gasses out through the exhaust valves.

As the piston continues its upward travel, past the 241° position 214, all valves and ports are closed, and the motion of the piston compresses the new intake air within the cylinder. Again, at the injection point 204 just before the piston reaches TDC 202, the fuel injector sprays fuel into the cylinder, the fuel is ignited and combustion of the fuel-air mixture at the combustion point 206 pushes the piston down in another power stroke 208. In this way, the cycle repeats for each cylinder in sequence, allowing the multiple cylinders in the engine to provide mechanical power to the crankshaft.

The firing order and the timing offsets for all of the cylinders of a 645E engine are well known to those of skill in the art. In a 16-cylinder version of this type of engine one of the sixteen cylinders fires with each 22.5° rotation of the crankshaft, which is 1/16 of a single 360° rotation of the crankshaft.

In order to change the fuel of the 645E engine from diesel to natural gas (NG), in accordance with the present disclosure, a variety of modifications have been devised, including changes to the air-fuel mix ratio, the method of ignition, and ignition control. While the present disclosure specifically shows the modification of a 645E engine to operate on natural gas, it is to be understood that the principles and concepts disclosed herein can potentially be applied to other engines, such as the 645E3 engine, etc.

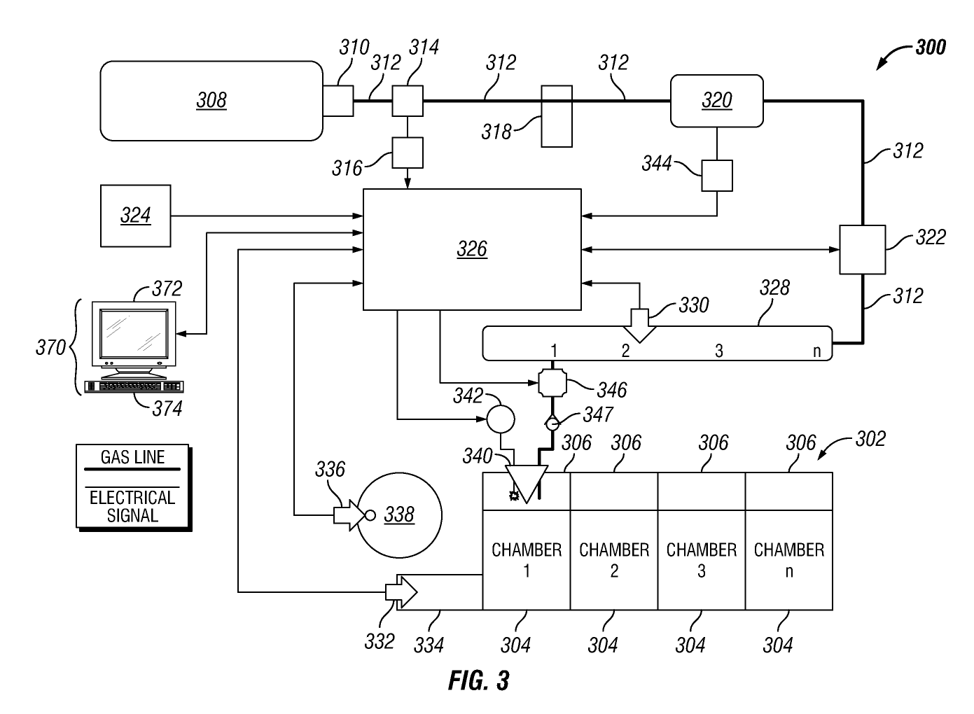

Shown in FIG. 3 is a schematic diagram of one embodiment of an engine and engine control system 300 for a 645E blower-type diesel engine 302 that has been modified to run on natural gas in accordance with the present disclosure. The modified engine 302 includes multiple cylinders/combustion chambers 304, with a combined fuel injection and ignition unit 306 disposed atop each cylinder 304. A pressurized fuel tank or reservoir 308 contains the NG fuel at high pressure (i.e. compressed natural gas, or CNG). A main valve 310 is positioned in the fuel line 312 adjacent to the fuel tank 308. An in-line high pressure valve 314 and gauge 316 are connected to the fuel line 312, and a fuel filter 318 is also positioned in the fuel line 312 to filter the fuel. A pressure reducer 320 is attached to the fuel line 312 to reduce the fuel pressure to a desired level, after which the fuel passes through a stepper motor 322 that controls the volumetric flow rate of the NG fuel. This stepper motor 322 can be a type of valve that is controlled by an electric motor that is adjusted manually by the throttle position sensor (TPS) 324, or automatically under control of the ignition control module (ICM) 326, as discussed in more detail below. The fuel at the desired pressure and flow rate is delivered to a fuel distribution line 328, which connects to each of the fuel injection and ignition units 306 and provides fuel to them.

At the heart of the control system is the ignition control module (ICM) 326, which can be a microprocessor/microcontroller device having a processor and memory, and which is programmed with instructions for controlling the operation of the fuel delivery and ignition components of the engine control system 300. The ICM 326 receives input from an engine fuel temperature sensor 330 disposed in the fuel distribution line 328, which measures the temperature of the gaseous fuel in order to allow the ICM 326 to calculate the right flow rate of fuel necessary for ignition under current operating conditions. The ICM 326 is also connected to an O₂ sensor 332, which is disposed in the exhaust conduit 334 and detects the level of oxygen in the engine exhaust gases, a crankshaft or flywheel sensor 336, which is associated with the engine flywheel 338 and monitors the speed of rotation of the engine and thus the position of the cylinders, allowing for accurate injection/ignition timing, the throttle position sensor 324, and a fuel pressure sensor 340, which measures the pressure of NG fuel in each fuel injection and ignition unit 306. The ICM 326 provides output to each of the fuel injection and ignition units 306 to control the volume and timing of fuel injection, and to each of the ignition coils 342 that are associated with each fuel injection and ignition unit 306, to control timing of ignition for each cylinder 304.

The ICM 326 can also receive NG fuel pressure information from the pressure reducer 320 through a pressure gauge 344 that is associated with it, and can provide output signals to the pressure reducer 320 to cause it to deliver NG at any selected pressure level, based on the engine operating parameters (described above) and on the demand coming from either the throttle position sensor (TPS) 324 or a generic governor mechanism (not shown). The ICM 326 can also receive input from and provide control output to the stepper motor 322. As noted above, this stepper motor 322 can be adjusted manually by the TPS 324. Alternatively, the stepper motor 322 can be controlled by the ICM 326 based on engine operating parameters, such as the readings of the O₂ sensor 332 (lambda).

The throttle position sensor (TPS) 324 dictates the air-fuel ratio (AFR) and can be set to various levels, depending on operating demands for the engine. For example, the AFR can be set to “rich” when maximum power is needed, at a “stoichiometric” level when high rotation of the engine is reached for cruise circumstances, and “lean” when the engine is at idle. It is to be understood that any desired AFR within a wide range can be used. As noted above, the O₂ sensor 332 is located at the exhaust conduit 334 and measures the O₂ present in the exhaust gases. If there is excess O₂ in the exhaust gas, a voltage is generated by the sensor 332 and can be measured. Relatively high concentrations of O₂ in the exhaust mixture indicates, for example, a lean AFR mixture. In this situation, the ICM 326 can send a signal to the stepper motor 322 to make fine adjustments in the NG flow to enrich the mixture.

The NG fuel is injected into the each cylinder/combustion chamber 304 only when the solenoid-actuated discharge valve 346 in the respective fuel injection and ignition unit 306 is open. This timing is also controlled by the ICM 326, which responds by processing the signals coming from the TPS 324, the O₂ sensor 332 and the flywheel sensor 336. A check valve 347 can be placed between the solenoid and the injector to prevent backflow of gases during ignition. The flywheel sensor 336 tells the ICM 326 the relative position of each piston inside its combustion chamber 304, and thus controls the sequence of the injection and the firing of the pistons properly. Through the flywheel sensor 336 the ICM 326 also calculates engine RPM, which, in turn is used in the decision process.

The ICM 326 is programmed to follow the original specifications of the 645E engine 302 in terms of operation (e.g. cylinder firing order, etc.) and also prevent the engine 302 from running outside of its limits, such as limits on RPM, temperature, and knocking. At the same time, the ICM 326 can optimize the efficiency of the engine.

As also shown in FIG. 3, the ICM 326 can provide real-time output data related to the performance of the engine through an electronic or computer display and/or a control panel 370, which can be located in the cab of a locomotive or at another engine operator location, for example. This control panel 370 can include a video display 372 and data input devices 374, such as a keypad or the like, and can assist in diagnosing malfunctions or other problems with operation of the engine. Alerts can be set for specific circumstances of operation, providing an indication to an operator or maintenance personnel of maintenance issues. The input devices 374 can also allow an operator to adjust or control settings of the ICM 326 in certain circumstances, if desired.

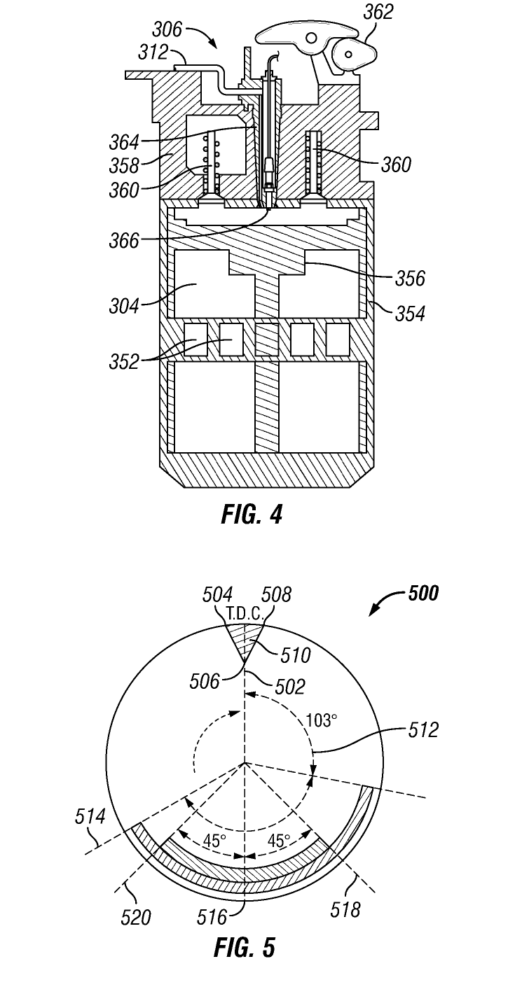

The modified engine 302 is substantially the same as the standard engine 100 shown and described above with respect to FIG. 1A. However, the modified engine 302 differs in certain ways that are further shown and described herein. The primary difference is the replacement of the standard diesel fuel injector (124 in FIG. 1A) with the fuel injection and ignition unit 306. Shown in FIG. 4 is a close-up cross-sectional view of the upper portion of a single cylinder 304 of a modified 645E blower-type diesel engine 302 that has been retrofitted with a fuel injection and ignition unit 306 in accordance with the present disclosure. In this view the intake ports 352 in the walls 354 of the cylinder 304 are visible, as is the piston 356. The cylinder head 358 includes the exhaust valves 360 and the camshaft 362, as well as the tapered fuel injector aperture 364, which leads to the upper portion of the cylinder 350. These components are all substantially the same as in the standard engine.

Advantageously, in place of a fuel injector (124 in FIG. 1A) a fuel injection and ignition unit 306 is disposed in the fuel injector aperture 364. Each fuel injection and ignition unit 306 is located and seated in the tapered hole 364 in the center of the cylinder head 358, with the spray tip 366 of the fuel injection and ignition unit 306 protruding slightly below the bottom of the head 358. Unlike the fuel injector (124 in FIG. 1A) that it replaces, the head 368 of the fuel injection and ignition unit 306 does not contact any part of the camshaft 362. Instead, actuation of the fuel injection and ignition unit 306 is controlled by the ICM 362 to inject fuel into the cylinder 304 and ignite it at a specific time with each rotation of the engine 302. The fuel injection and ignition unit 306 is responsible to inject the right amount of fuel at the precise time, and ignite that fuel at the precise time. Pressure, flow rate of the NG fuel and volume of NG delivered are controlled by the ignition control module 326, and determined based on engine load, RPM, throttle position, oxidation rate (lambda—which indicates the quality of the combustion based on the original mix rate), temperature, etc. The frequency of fuel injection is determined by the flywheel angular speed, which directly indicates engine RPM and angular position of the crankshaft. Additional details of the fuel injection and ignition units 306 are provided below.

Shown in FIG. 5 is a timing diagram 500 for one cylinder of a 645E blower-type diesel engine that has been retrofitted to run on natural gas using a fuel injection and ignition unit in accordance with the present disclosure. This diagram is similar to that of FIG. 2, but demonstrates some of the differences that the present system and method provide. As the piston approaches the TDC position 502, all valves are closed and the fuel-air mixture inside the cylinder is compressed. At a fuel injection point 504 before the piston reaches TDC 502 (e.g. 4° before TDC 502), the fuel injection and ignition unit (306 in FIGS. 3, 4) begins to inject fuel into the cylinder. After injection of the fuel, ignition occurs at an ignition point 506 due to the operation of a spark plug that is included in the fuel injection and ignition unit 306. The ignition point 506 can be before, at, or after the TDC point 502. Injection of the fuel into the cylinder can continue for an injection time that ends at point 508, which can be before or after the ignition point 506. The length of the shaded region 510 along the perimeter of the circle in FIG. 5 represents the total time for fuel delivery and for total burn of the mixture, while the area of the shaded region 510 generally represents the total volume of fuel that is injected in a given cycle.

As discussed with respect to FIG. 2, the fuel burns rapidly and forces the piston down in the power stroke of the piston, indicated at 512. Once the piston moves downward and rotates the crank a given angular amount during the power stroke 512, the exhaust valves and intake ports open and close at the same respective points discussed above with respect to FIG. 2. As the piston continues its upward travel, past the 241° position 514, all valves and ports are again closed, and the cycle repeats itself.

The flow rate and injection time (e.g. amount of fuel injected) of the NG fuel determines the air-fuel ratio (AFR) of the mixture formed after the NG injection. The ideal AFR for total burn of the NG, called stoichiometric oxidation, is around 9:7:1 by volume. However, for specific circumstances, a lean mixture (high air-fuel ratio) can be created, such as for light load or low speed (e.g. idle) operation, or a rich mixture (low air-fuel ratio) can be created, such as for high speeds or heavy loads on the engine.

Referring again to FIG. 3, the fuel injection and ignition unit 306 is configured to deliver the NG fuel into the cylinder 304 at any time under the control of the ignition control module 326. In the modified engine 302 the fuel injection and ignition unit 306 is actuated by the solenoid actuated discharge valve 346 rather than the overhead camshaft (362 In FIG. 4), through an electrical signal generated by the ignition control module 326, as discussed above. Accordingly, the rocker arm (128 in FIG. 1A) that actuated the fuel injector (124 in FIG. 1A) or the injector shaft, or both, can be removed. The timing of fuel injection, which was formerly controlled by the rocker arm, is calculated by the ignition control module 326 through the position sensor 336 on the flywheel 338.

Timing of the injection can be very precise, since the window for beginning injection of the gas into the cylinder occurs after both the intake and the exhaust valves close and before the piston reaches TDC (502 in FIG. 5). It is to be understood that the modified engine 302 is unchanged with respect to the exhaust valves (122 in FIG. 1A). In the modified engine 302 the exhaust valves are still controlled by the camshaft (120 in FIG. 1A) through the rocker arms (128 in FIG. 1A), so that their timing remains unchanged. As RPM or load on the engine increases, the size of the time window that is available for injection of the fuel shortens. When RPM increases but load does not increase, the timing of NG delivery into the cylinder is advanced (i.e. occurs sooner) before the piston reaches TDC, to allow more time for the total burn of the mixture to occur. When the load on the engine increases, either with or without an RPM increase, the fuel delivery timing is also advanced, because more fuel is to be delivered (i.e. a rich mixture), and fuel delivery is therefore commenced sooner relative to TDC in order to allow more time for the fuel delivery and for total burn of the mixture to occur. All of these factors are taken into account by the ignition control module 326 through the various sensors. The ignition control module 326 can recalculate new timing and fuel injection volumes with every revolution of the engine in order to maintain the desired power and performance of the engine.

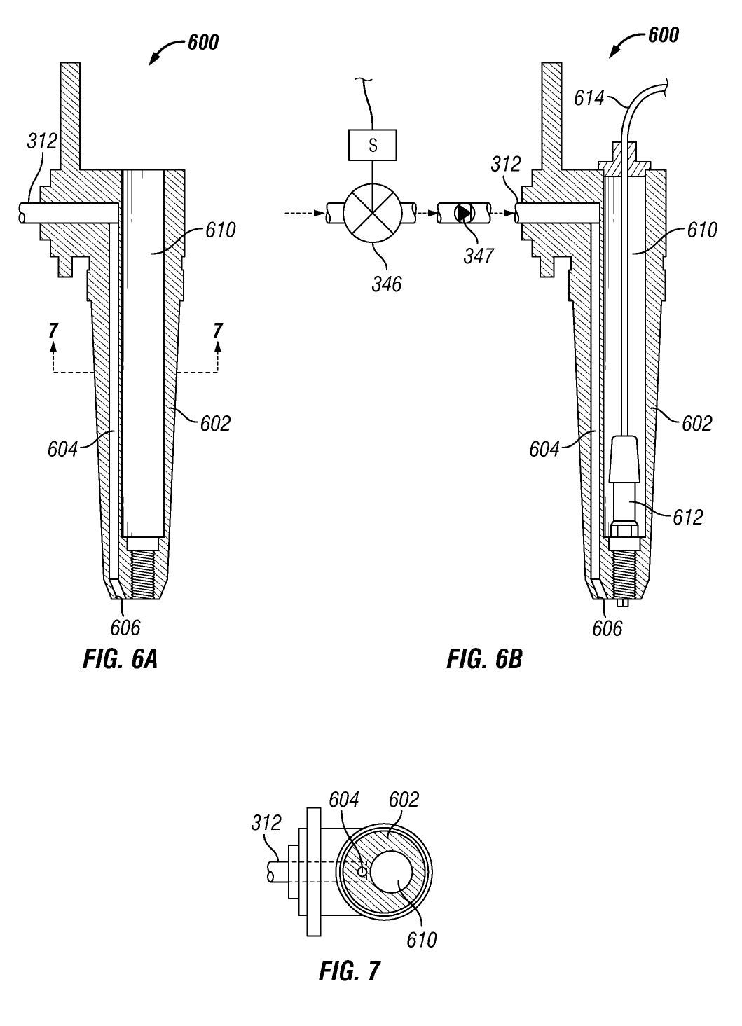

The integrated fuel injection and ignition unit (306 in FIGS. 3, 4) contains both the natural gas fuel injection apparatus, and a spark plug, and is controlled by the ignition control module (326 in FIG. 3), as discussed above. Two embodiments of the fuel injection and ignition unit are shown and described below with respect to FIGS. 6A-9B.

In the embodiments shown herein, the fuel injection and ignition unit can be configured of either one or two pieces. In both embodiments, the fuel injection and ignition unit has the same shape and size as the diesel fuel injector (124 in FIG. 1A) of the standard 645E engine, in order to fit the tapered fuel injector aperture (364 in FIG. 4) of the engine and still preserve the same sealing of the combustion chamber.

Referring to FIGS. 6A-B and 7, in one embodiment a one-piece fuel injection and ignition unit 600 in accordance with the present disclosure has a tapered body 602 and contains a fuel canal 604 that delivers the natural gas fuel into the combustion chamber under pressure through a nozzle 606. In order to flow into the cylinder during the compression phase of the piston, the pressure of the Natural Gas (NG) fuel is greater than the pressure of the compressed air inside the cylinder. As discussed above, the flow rate or amount of NG delivered into the cylinder with each stroke is controlled by the ignition control module (326 in FIG. 3), based on parameters such as RPM, engine load, etc, and can be adjusted based on the gauge (i.e. diameter) of the fuel canal 604 and the pressure of the gas being injected. Unlike diesel fuel, which in the standard 645E engine is injected into the combustion chamber as an atomized liquid, the Natural Gas fuel is injected into the combustion chamber in a gaseous state.

The fuel canal 604 in the fuel injection and ignition unit 600 is connected to the solenoid actuated discharge valve 346 (also shown in FIG. 3), which retains the pressurized NG, and the injection port or nozzle 606 at the distal end of the fuel injection and ignition unit 600. The pressure of the NG also is controlled by the ICM (326 in FIG. 3), which determines all of the fuel injection parameters (flow rate, pressure, etc.) based on the operating parameters of the engine. A check valve 347 can be positioned between the lower tip 606 of the fuel canal 604 and the control valve 346 in order to prevent the propagation of combustion from the combustion chamber to the fuel line 312 (also shown in FIG. 3), and also to avoid impact on the ports, which could stress and damage the valve. Alternatively, solenoid control injectors that are designed to tolerate the high pressures of combustion can be used, as noted below.

The lower tip or nozzle 606 of the fuel canal 604 of the fuel injection and ignition unit 600 is oriented at an angle relative to the cylinder. This helps to create turbulence inside the chamber, which, along with the compression process as the piston approaches TDC, contributes to homogeneity of the air-fuel mixture inside the chamber. This promotes faster and more complete combustion, resulting in higher instantaneous temperature increase and higher torque output.

The standard 645E blower-type diesel engine is fundamentally mechanically controlled. That is, as a diesel engine there is no electric spark that is needed for combustion, and the flow rates of both fuel and air into the cylinders and the operation of the exhaust valves and other components are mechanically governed by the motion of the pistons and rotation of the overhead cam, which in turn govern the output of the blower and fuel injectors. Combustion is triggered by the heat generated by the adiabatic compression of the air-fuel mixture. Conversion of the 645E engine to the use of natural gas in the manner disclosed herein involves providing spark plugs for the engine. As shown in FIG. 6B, the fuel injection and ignition unit 600 contains a spark plug cavity 610 that supports and retains a spark plug 612. The spark plug 612 can be removable from the spark plug cavity 610, or it can be built into the fuel injection and ignition unit 600. The relative diameters and positioning of the fuel canal 604 and spark plug cavity 610 within the tapered body 602 of the fuel injection and ignition unit 600 are shown in the cross-sectional view of FIG. 7.

A long, thin and durable spark plug 612 is believed to be desirable for this application for several reasons. First, it is desirable to have the electrode of the spark plug close to the combustion chamber in order to decrease the chances of a misfire or failure of combustion during any given cycle. Also, assuming that the fuel-air mixture is generally homogeneous, it is desirable that the ignition be as quick as possible. For this purpose, a close source of spark helps increase the chances of fast propagation of the combustion and decreases the time of oxidation of the fuel, which in turn results in better performance of the engine. As a consequence, the ignition temperature increases, which can stress and degrade the material of the spark plug sooner than in other circumstances. To help prevent this, a long spark plug is used, which leaves more room inside the fuel injection and ignition unit 600 (relative to its diameter), which can be used for the fuel canal 604. These types of spark plugs are commonly used in racing engines and motorcycles and are commercially readily available. For example, a CR10YS Silver racing spark plug, available from Brisk USA Enterprises, LLC of Humble, Tex., can be used.

The spark plug 612 of each fuel injection and ignition unit 600 is connected to an individual coil (342 in FIG. 3) via a spark plug wire 614, which supplies the high voltage necessary to create a good spark. The timing of the spark is controlled by the ignition control module (326 in FIG. 3), which provides an outside electronic device that controls the coordination of the spark timing along with the fuel delivery and the engine operating parameters. For example, the spark timing can be advanced by the ignition control module 326 to initiate the combustion process earlier relative to TDC as the AFR becomes richer. The spark frequency is related to the RPM of the engine. The ignition control module 326 thus provides a modified control system in order to optimize the efficiency of the engine and its operation when modified to use NG fuel in accordance with this disclosure.

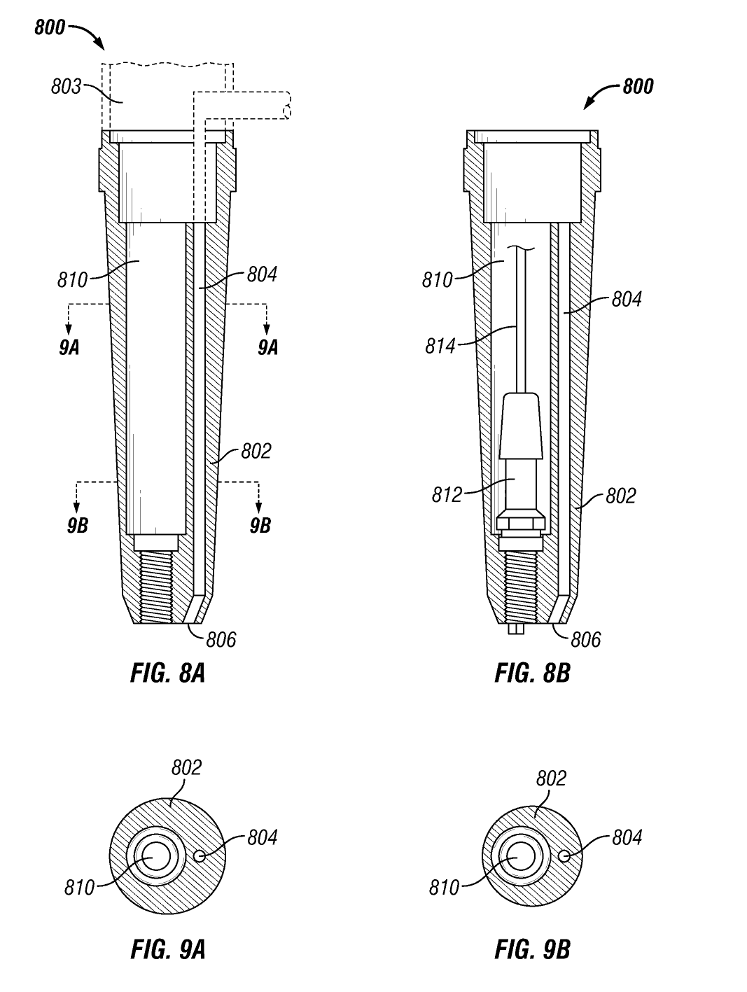

As noted above, the fuel injection and ignition unit (306 in FIG. 3) can also be configured in two pieces. Referring to FIGS. 8A-B and 9A-B, in another embodiment a two-piece fuel injection and ignition unit 800 in accordance with the present disclosure has a tapered lower body 802 and a separate head 803, which can be removed from the lower body 802 during conversion of an existing injector to supply NG fuel, and also during maintenance activities, etc. The lower body 802 contains a fuel canal 804 that delivers the natural gas fuel into the combustion chamber under pressure through a nozzle 806, which is oriented at an angle, for the same reasons discussed with respect to the embodiment of FIGS. 6A-B. The fuel canal 804 is connected to the fuel line 312 (also shown in FIG. 3) through the solenoid actuated discharge valve 346 (also shown in FIG. 3), and the injection port or nozzle 806 at the distal end of the fuel injection and ignition unit 800. A check valve (not shown) can also be positioned between the fuel injection and ignition unit 800 and the control valve (346 in FIGS. 3, 6A-B), in the same manner as shown and discussed above with respect to the embodiment of FIGS. 6A-B.

The two-piece fuel injection and ignition unit 800 also contains a spark plug cavity 810 that supports and retains a long, thin spark plug 812. The spark plug 812 is connected to an individual coil (342 in FIG. 3) via a spark plug wire 814, which supplies the high voltage necessary to create a good spark. While the spark plug 812 can be built into the lower body 802 of the fuel injection and ignition unit 800, the two-piece configuration of FIGS. 8A-B is designed so that the head 803 can be removed from the lower body 802 without removing the entire fuel injection and ignition unit 800 from the engine, in order to facilitate removal and/or replacement of the spark plug 812.

The relative diameters and positioning of the fuel canal 804 and spark plug cavity 810 within the tapered lower body 802 of the fuel injection and ignition unit 800 are shown in the cross-sectional views of FIGS. 9A and 9B. From these figures the tapered configuration of the fuel canal 804 and spark plug cavity 810 can be seen. The long, thin and durable spark plug 812 leaves more room inside the fuel injection and ignition unit 800 (relative to its diameter), which can be used for the fuel canal 804. The fuel injection and ignition unit 800 is relatively simple and compact, and is externally electronically controlled, as opposed to the mechanical rocker arm control in the original engine. As discussed above, the timing of fuel injection and timing of the spark are both controlled by the ignition control module (326 in FIG. 3), which provides an outside electronic device that controls the coordination of the spark timing along with the fuel delivery and the engine operating parameters. This control system can provide excellent performance in the modified engine.

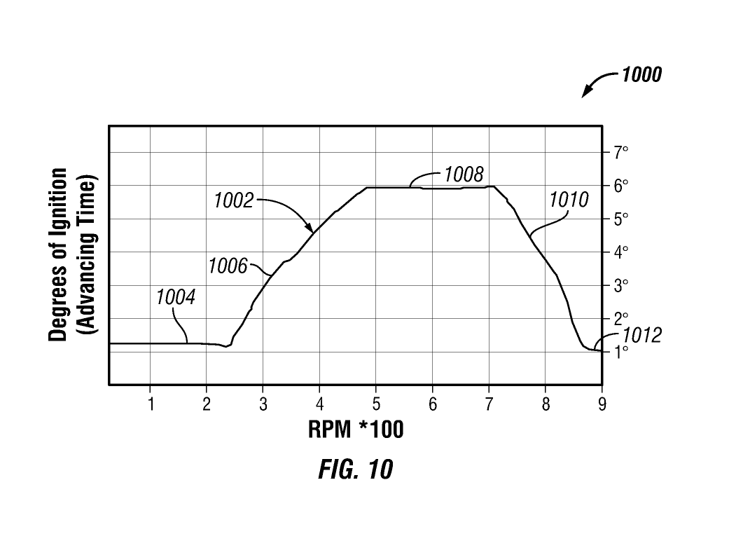

A performance curve of the operation of the engine can be created and stored in memory in the ICM 326 for engine timing and other computational purposes. An exemplary performance graph 1000 is shown on FIG. 10. In this chart the horizontal axis represents engine speed (RPM), while the vertical axis represents a range of ignition timing advancement positions in angular degrees. The performance curve 1002 represents different timing advancement positions depending on the engine speed. Low idle speed for this engine is between 235 and 255 RPM. When the engine operates in this speed range, the timing of ignition can be a bit above 1 (one) degree before Top Dead Center, as indicated by the left portion 1004 of the performance curve 1002. As the engine revs up to standard idle speed, around 318 RPM, the rising portion 1006 of the performance curve 1002 shows that timing can be advanced to a little more than 3 (three) degrees before Top Dead Center. As engine speed increases into the cruise range 1008 of the curve 1002, the curve flattens out from around 500 to 700 RPM and the timing is advanced to around 6 (six) degrees before Top Dead Center. As engine speed increases from 700 RPM to full speed (900 RPM), the trailing section 1010 of the performance curve 1002 indicates that timing can be retarded back to around 1 (one) degree before Top Dead Center, as indicated at 1012. As indicated by this curve 1002, for each speed the ignition system, controlled by the ICM 326, adjusts the timing of the injection and firing, in view of the various parameters discussed above.

Although various embodiments have been shown and described, the present disclosure is not so limited and will be understood to include all such modifications and variations are would be apparent to one skilled in the art.

What is claimed is:

1. A method for converting a fuel-injected diesel engine to be powered by natural gas, comprising:
removing a fuel injector from a cylinder of the engine;
replacing the removed fuel injector with a combined fuel injection and ignition unit having a natural gas flow path and configured to inject the natural gas into the cylinder, and an ignition device configured to ignite the natural gas in the cylinder;
coupling the natural gas flow path to a pressurized natural gas fuel supply; and
connecting the ignition device to an ignition control system, configured to coordinate injection and ignition of the natural gas fuel for operation of the engine.

2. A method in accordance with claim 1, wherein replacing the removed fuel injector with a combined fuel injection and ignition unit comprises inserting a combined fuel injection and ignition unit having a profile that matches a profile of the fuel injector and of an aperture of the engine configured for receiving the fuel injector.

3. A method in accordance with claim 1, wherein connecting the ignition device to an ignition control system comprises connecting a spark plug and a unique coil, associated with the spark plug, to the ignition control system, whereby discharge of the spark plug is controllable by a signal from the ignition control system to the coil.

4. A method in accordance with claim 1, wherein coupling the natural gas flow path to a pressurized natural gas fuel supply comprises coupling the natural gas flow path to a fuel distribution conduit in which the pressure and flow rate of the natural gas are selectively controlled by the ignition control system.

5. A method in accordance with claim 4, further comprising coupling the ignition control system to a pressure control valve and a stepper motor, the pressure control valve configured to control the pressure of the natural gas based on signals from the ignition control system, and the stepper motor configured to control the flow rate of the natural gas based on signals from the ignition control system.

6. A method in accordance with claim 1, wherein connecting the ignition device to the ignition control system comprises:
connecting the ignition device and a check valve disposed at a discharge end of the natural gas flow path to an ignition control module, the ignition control module comprising a microprocessor device having a processor and system memory and provided with program code for analyzing input data and providing output signals to the fuel injection and ignition unit;
coupling a plurality of sensors to the ignition control module, the sensors configured provide input regarding operational parameters of the engine, wherein the ignition control module is configured to control the flow of natural gas to the cylinder and to control the timing of discharge of the ignition device based on the sensor input.

7. A method in accordance with claim 6, wherein coupling a plurality of sensors to the ignition control module comprises coupling an engine rotation sensor, an exhaust oxygen sensor, a throttle position sensor, a fuel pressure sensor and a fuel flow rate sensor to the ignition control module.

8. A method in accordance with claim 6, further comprising storing in memory in the ignition control module an ignition timing table, the ignition timing table providing fuel injection and ignition timing data relative to operational parameters of the engine.

9. A natural gas engine system, comprising:
a piston engine, having multiple cylinders, originally adapted to burn diesel fuel introduced into each cylinder via a fuel injector associated with each cylinder;
a natural gas fuel supply;
a fuel injection and ignition unit, associated with each cylinder in place of the fuel injectors, connected to the natural gas fuel supply, having a fuel flow path and an ignition device, configured to introduce fuel into the respective cylinder and to ignite the fuel therein; and
an ignition control system, coupled to the natural gas fuel supply and the fuel injection and ignition unit, configured to control the introduction of the natural gas fuel into the respective cylinder and to ignite the fuel via the fuel injection and ignition unit.

10. A system in accordance with claim 9, wherein the fuel injection and ignition unit further comprises:
a flow channel, in selective fluid communication between the natural gas fuel supply and a combustion chamber of the respective cylinder;
a check valve, disposed at a discharge end of the flow channel, controlled by the ignition control system;
a spark plug, disposed in communication with the combustion chamber; and
a coil, connected to the spark plug and controlled by the ignition control system, configured to provide an electric charge to the spark plug for timed ignition of the natural gas fuel.

11. A system in accordance with claim 9, wherein the natural gas fuel supply further comprises:
a fuel reservoir, adapted to contain natural gas fuel at elevated pressure;
a fuel line, extending from the fuel reservoir to the fuel injection and ignition unit;
a pressure control device, disposed in the fuel line, configured to adjust the pressure of the natural gas fuel; and
a stepper motor, disposed in the fuel line, configured to control a rate of flow of the natural gas fuel into a fuel distribution line in communication with each fuel injection and ignition unit associated with each cylinder, the pressure control device and stepper motor being controlled by the ignition control system to provide fuel to the at a selected pressure and volumetric flow rate to each of the fuel injection and ignition unit.

12. A system in accordance with claim 9, wherein the ignition control system further comprises:
an ignition control module, comprising a microprocessor device having a processor and system memory and provided with program code for analyzing input data and providing output signals;
a plurality of sensors, coupled to provide input to the ignition control module regarding operational parameters of the engine, wherein the ignition control module controls the flow of natural gas into the combustion chamber and controls the discharge of the ignition device.

13. A system in accordance with claim 12, further comprising:
a flywheel, attached for synchronous rotation with the engine;
a pressure control device, configured to adjust the pressure of the natural gas fuel;
a stepper motor, configured to control a rate of flow of the natural gas fuel into a fuel distribution line in communication with each fuel injection and ignition unit associated with each cylinder; and
wherein the plurality of sensors comprise:
a flywheel sensor, associated with the flywheel, configured to provide engine rotation data to the ignition control module;
an oxygen sensor, disposed in an exhaust system of the engine, configured to provide exhaust oxygen concentration data to the ignition control module; and
a throttle position sensor, configured to provide throttle position data to the ignition control module;
the pressure control device and stepper motor being controlled by the ignition control module to provide fuel to the fuel injection and ignition units at a selected pressure and volumetric flow rate based upon analysis by the ignition control module, of the sensor input.

14. A system in accordance with claim 12, wherein the ignition control module further comprises a timing table, stored in memory, providing fuel injection and spark ignition timing data relative to an angular speed of the flywheel and throttle position for a range of operating conditions of the engine.

15. A system in accordance with claim 9, wherein the piston engine comprises a series 645E blower-type diesel engine associated with a railroad locomotive.

16. A fuel injection and ignition unit for converting a diesel piston engine having multiple cylinders to burn natural gas, comprising:
a body, configured to replace a diesel fuel injector associated with a cylinder of the piston engine, the body having a proximal end, configured to receive natural gas fuel at an elevated pressure, and a distal end that is positionable at a combustion chamber of the cylinder;
a fuel flow channel, extending from the proximal end to the distal end;
a discharge port at the distal end, in communication with the fuel flow channel, configured to introduce fuel into the combustion chamber; and
an ignition device, disposed at the distal end, configured to ignite the fuel in the combustion chamber.

17. A fuel injection and ignition unit in accordance with claim 16, further comprising a check valve, disposed at the discharge port and controllable by an ignition control system, configured to selectively open to allow fuel to flow from the discharge port, and to close to prevent combustion gasses from entering the fuel flow channel.

18. A fuel injection and ignition unit in accordance with claim 16, wherein the ignition device comprises a spark plug, controllable by an ignition control system for timed ignition of the fuel.

19. A fuel injection and ignition unit in accordance with claim 18, wherein the spark plug is removable from the body of the fuel injection and ignition unit.

20. A fuel injection and ignition unit in accordance with claim 16, wherein the body has a taper that substantially matches a taper of the diesel fuel injector.
